(19) United States
(12) Patent Application Publication
(10) Pub. No.: US 2005/0229142 A1
(43) Pub. Date: Oct. 13, 2005

(54) System and method for automated accurate pre-layout estimation of standard cell characteristics

(75) Inventors: Vamsi Boppana, Sant Clara, CA (US); Hiroaki Yoshida, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Zenasis Technologies, Inc.

(21) Appl. No.: 10/822,158

(22) Filed: Apr. 9, 2004

(51) Int. Cl. G06F 17/50

(52) U.S. Cl. 716/17; 716/4

(57) ABSTRACT

An automated computer-implemented method, storage medium, and system for obtaining a pre-layout estimation of a characteristic of a standard cell including receiving a pre-layout netlist of a standard cell, applying at least one transformation to the pre-layout netlist to obtain an estimated representation, and characterizing the estimated representation to obtain a pre-layout estimation of the characteristic of the standard cell.

### FIELD OF THE INVENTION

The present invention relates to the design of integrated circuits (ICs), and in particular to a method and system for an accurate pre-layout estimatimation of standard cell characteristics.

### BACKGROUND OF THE INVENTION

There is constant pressure in the field of IC design to reduce the size of ICs and yet increase the density and processing speeds of ICs. With the advent of deep-submicron technologies, it has become essential to model the impact of physical/layout effects upfront in all design flows. The effect of layout parasitics is considerable, even at the intra-cell level in standard cells. This is particularly true at the 130 nm and at the 90 nm process nodes. For example, without taking cell parasitics into account, standard cell delays can be off by as much as 15% (i.e., up to 30-40 ps, for cell delays that are approximately 200 ps). Thus, cell parasitics cannot not be ignored if an accurate predictor of the performance of the cell is desired.

Traditionally, transistor-level optimization techniques have not attempted to account for the impact of layout parasitics. However, layout parasitics have become increasingly important at the 130 nm and at the 90 nm process nodes. The effect of these layout parasitics has become extremely important, even for circuits with a small number of transistors (e.g., approximately 10 transistors). Thus, an optimization technique or flow that does not consider parasitic layout effects may be impractical and/or wasteful of design resources.

Additionally, reduced order device models such as switch-level (RC) models of transistors are becoming increasingly incapable of modeling deep submicron effects. This requires detailed simulation, often at the BSIM3/4 level, or using detailed models built using simulation at that level, as the only reliable option for obtaining accurate circuit timing.

Therefore, it has become critically important for any transistor-level optimization to consider the effect of layout parasitics as an integral part of the optimization process. However, it is not computationally feasible for the actual layout to be a part of any such optimization procedure. Hence, there exists a need for a method and system that estimates cell layout characteristics without actually performing the layout and subsequent extraction steps.

### SUMMARY OF THE INVENTION

The teachings of the present disclosure provide, inter alia, an automated computer-implemented method, storage medium, and system for a pre-layout estimation of characteristics of a standard cell including receiving a pre-layout representation of a standard cell, applying at least one transformation to the pre-layout representation to obtain a representation with estimated parasitics, designated an estimated representation, and characterizing the estimated representation to obtain a pre-layout estimation of the standard cell's characteristics. Such characteristics may include timing, power, noise, and other cell characteristics that are sensitive to accurate estimation of inter-cell parasitics.

The above and other objects, advantages, and benefits of the present invention will be understood by reference to following detailed description and appended sheets of drawings.

### BRIEF DESCRIPTION OF THE DRAWINGS

FIG. 1 is a table of data;

FIG. 2 depicts three transistor-level optimization approaches for optimizing a design;

FIG. 3 depicts three transistor-level optimization approaches for optimizing a cell;

FIG. 4 is a depiction of a layout of a cell in accordance with the teachings herein;

FIG. 5(a) is a circuit model in accordance with the teachings herein;

FIG. 5(b) is a circuit model in accordance with the teachings herein, including folded transistors and wiring capacitances added thereto;

FIG. 6 is a depiction of a MTS (Maximal Transistor Series) hereof;

FIG. 7 is depicts an estimation of diffusion and perimeter of a standard cell of the present teachings;

FIG. 8 depicts an exemplary wiring capacitance estimation, in accordance with the teachings herein;

FIGS. 9(a) and 9(b) depict scatter diagrams of extracted versus estimated capacitances, in accordance with the teachings herein;

FIG. 10 is an exemplary tabular listing of data; and

FIG. 11 is an exemplary a tabular listing of data.

### DETAILED DESCRIPTION OF THE INVENTION

By way of background, it is noted that design optimization at the transistor-level has been successfully used to achieve significant performance benefits above and beyond gate-level design optimization. Design optimization approaches range from transformations such as transistor sizing to macro-cell based design methodologies.

Recently, transistor-level optimization techniques targeting a standard-cell based design flow have been proposed. These optimization techniques take advantage of the recent progress in automated cell-layout solutions. Such solutions are now being increasingly used in the creation of high-performance cell libraries and are equipped to handle a variety of manufacturing, design and cost considerations used in the creation of cell libraries.

In order to demonstrate the effect of cell layout parasitics on cell timing, a typical standard cell from an industrial library at 90 nm is used to demonstrate the impact of three of the most important layout characteristics on the timing of the cell under consideration. The three selected layout characteristics are (1) transistor folding, (2) diffusion parasitics, and (3) wiring capacitances.

Transistor folding refers to the process of splitting a wide transistor in a pre-layout netlist into smaller parallel-connected transistors during layout, to meet a target cell height. Transistor folding is also important for minimizing the area of a cell. Diffusion parasitics refers to transistor diffusion regions (i.e., drain and source) that have parasitics. Wiring capacitances refer to routing wires having capacitances to neighboring wires and substrate.

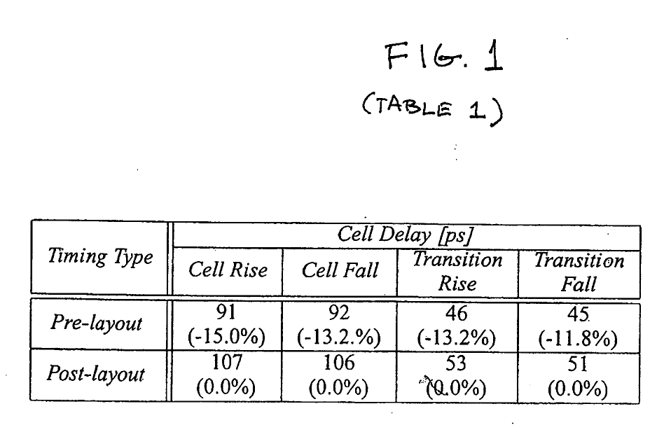

Table 1 of FIG. 1 shows the impact of pre-layout and post-layout characteristics of an exemplary standard cell from an industrial library at 90 nm. The first column of Table 1 lists the timing type, i.e., pre-layout timing or post-layout timing. The other columns list the values of the four types of cell delays, i.e., cell rise, cell fall, transition rise, and transition fall. The numbers in parentheses correspond to the percentage differences compared with post-layout timing. According to the example of Table 1, layout characteristics can impact cell delays by up to 15%, the worst absolute difference being 16 ps for the exemplary standard cell's rise time.

Accordingly, Table 1 demonstrates and documents that it is critically important for a transistor-level optimization to consider the effects of layout parasitics as an integral part of the optimization process.

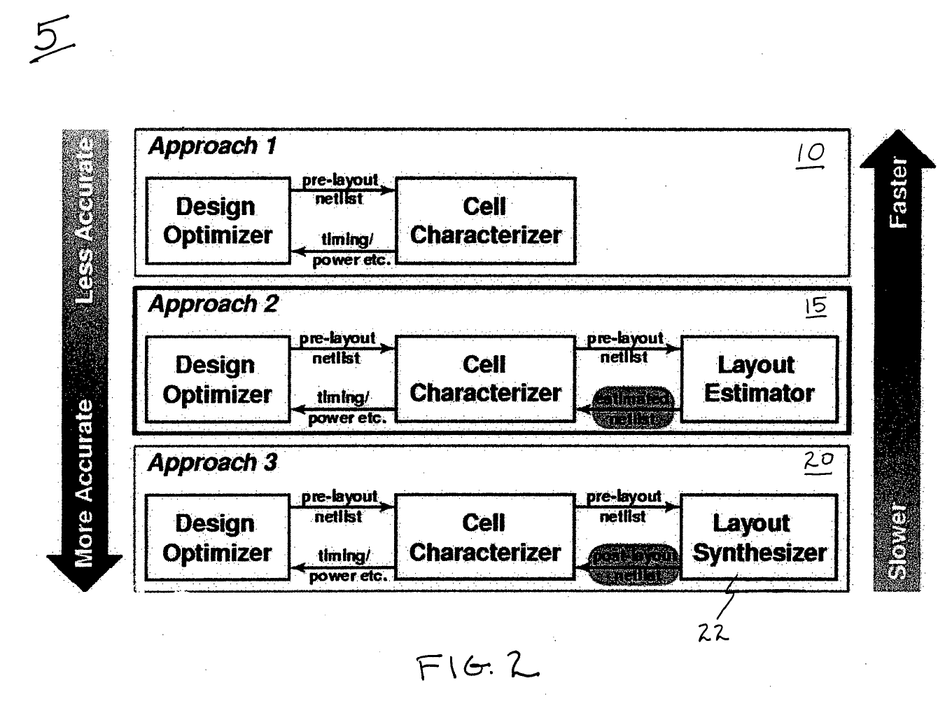

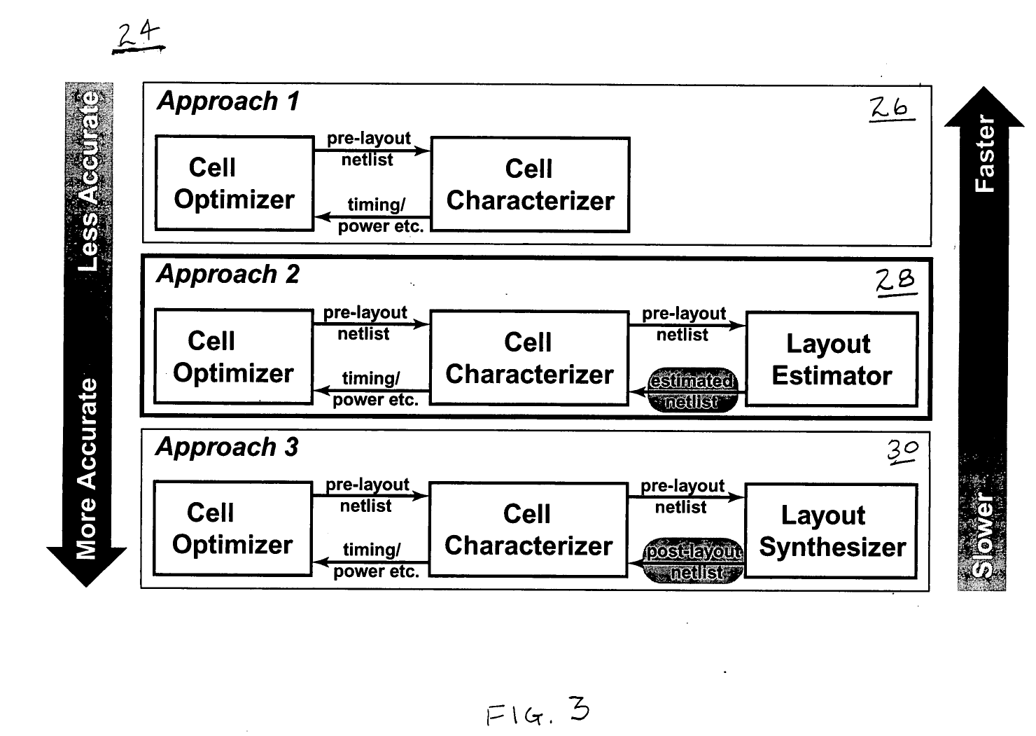

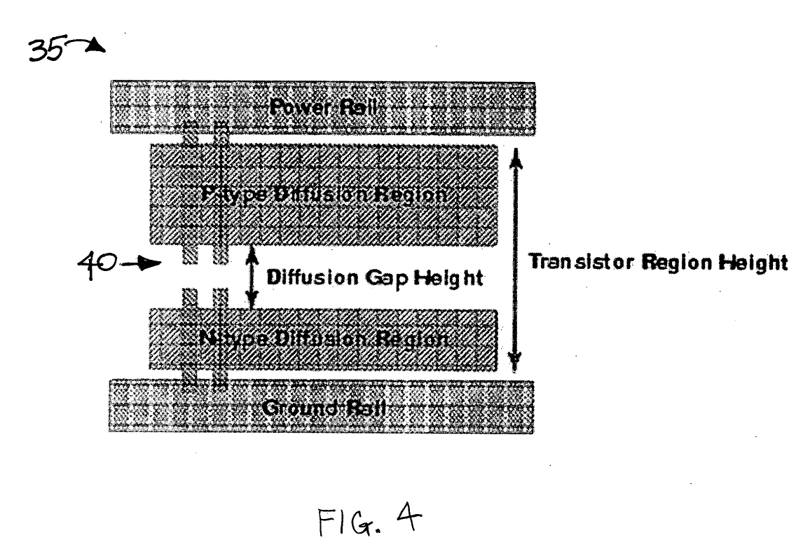

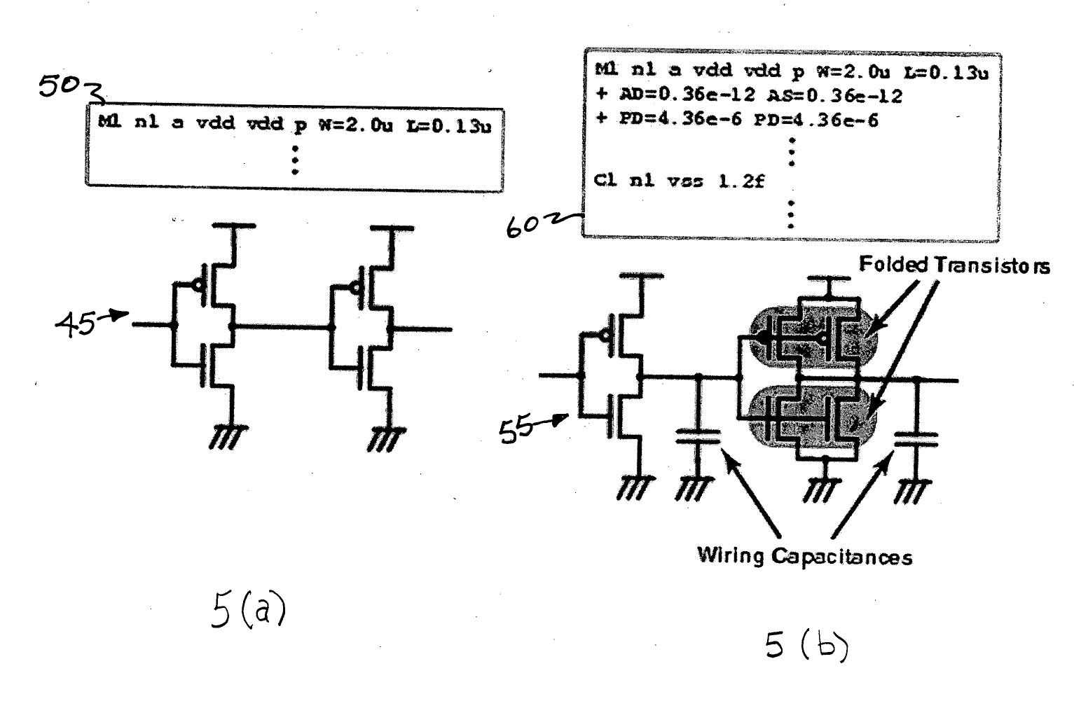

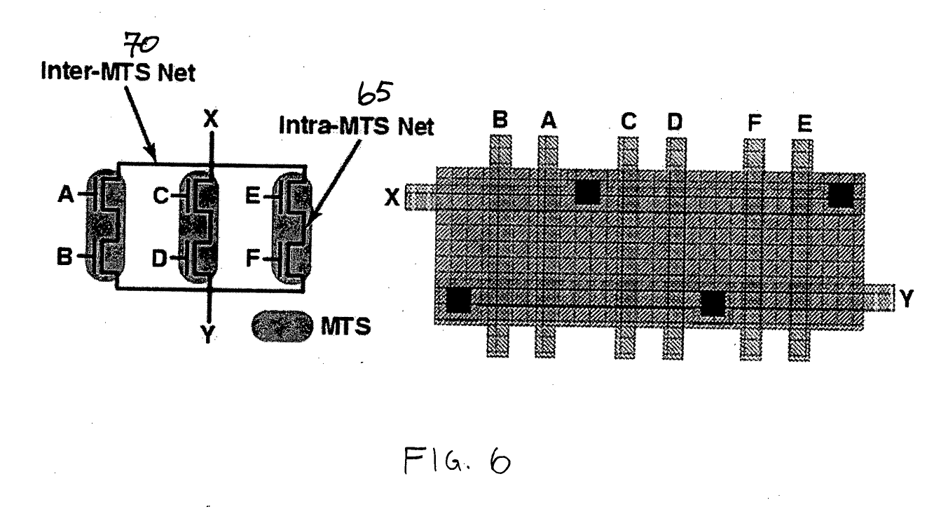

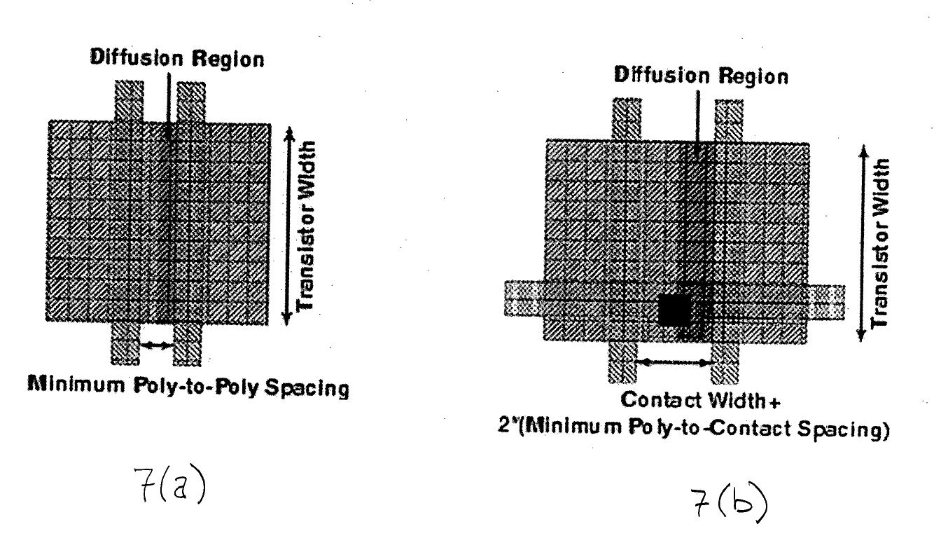

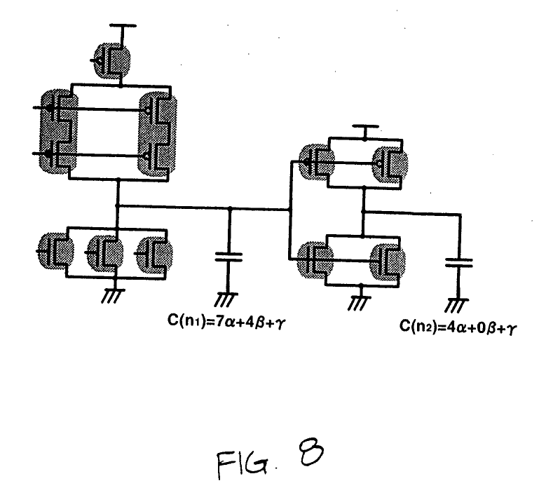

Of the three design optimization approaches depicted in FIG. 2, Approach 1 (10) is not practical for deep submicron geometries. Although Approach 1 can be performed relatively fast, the accuracy thereof limits its usefulness. On the other hand, it is not computationally feasible to wait for the actual layout to be a part of any such optimization approach or procedures, as included in Approach 3 (20). As shown, Approach 3 performs a layout synthesis using layout synthesizer 22.

Hence, the teachings herein provide a method and system of obtaining an accurate estimate of cell layout characteristics without actually performing the layout and subsequent extraction steps (i.e., an accurate pre-layout estimation of the cell's layout characteristics)—during optimization of a design that uses cells created on-the-fly. This method, Approach 2 (15), is captured conceptually in FIG. 2.

FIG. 3 depicts three cell optimization approaches, 24. Approach 1 (26), using a cell optimizer and a cell characterizer, is not practical for deep submicron geometries. Approach 1 can be performed relatively fast but the accuracy thereof limits its usefulness. Alternatively, it is not computationally feasible to wait for the actual layout of the cell to be included as part of any such optimization approach or procedure, as depicted in Approach 3 (30). Approach 3, using a cell optimizer, a cell characterizer, and a layout synthesizer, performs an actual layout synthesis.

As with Approach 2 (15) of FIG. 2, Approach 2 (28) of FIG. 3 conceptually depicts a method and system of obtaining an accurate estimate of cell layout characteristics without actually performing the layout and subsequent extraction steps (i.e., an accurate pre-layout estimation of the cell's layout characteristics)—with the purpose of creating an optimized cell design, e.g., while creating a library of standard cells.

The teachings herein provide an accurate estimate of the layout effects to get timing characteristics that are on average, preferably, within about 1.5% of post-layout timing. The technique is preferably thousands of times faster than the actual creation of layout.

As used herein, a cell refers to a typical standard cell. FIG. 4 illustrates an exemplary cell layout model. Cell 35 is of a single-height style, i.e., P-type and N-type transistors are placed in diffusion regions as shown. Transistor stacking is not allowed. The region between the two diffusion regions is referred to as a diffusion gap region 40. Maximum diffusion heights are either fixed or flexible, depending on the layout style. Transistors are connected by using either wires or diffusion.

FIGS. 5(a) and 5(b) illustrate exemplary circuit models in accordance with the teachings herein. A cell may be represented in a number of ways, such as but not limited, a netlist. A pre-layout representation of a cell provides a pre-layout representation of a cell. The pre-layout representation may be selected from a wide variety of possibilities such as a spice netlist, a BDD-based transistor structure representation, a pre-layout structural representation like stick diagram, etc.

A pre-layout netlist 50 and 60 is a set of transistors and nets that connect the transistors. Each transistor in a pre-layout netlist has a length and width. An estimated netlist is defined as a pre-layout netlist with the following modifications: (1) each transistor has the areas and perimeters of its drain and source diffusion regions in addition to its width and length, and (2) each net has an associated grounded capacitance.

An estimated netlist is functionally identical to a corresponding pre-layout netlist but can be structurally different due to transistor folding. That is, a wide transistor in a pre-layout netlist may be split into smaller parallel-connected transistors in the estimated netlist.

A Maximal Transistor Series (MTS) is a maximal set of series-connected transistors. FIG. 6 illustrates an example of an MTS and its physical implementation. MTS identification is an essential step in building a high-quality estimator of the timing delays of the cell.

In a physical layout, an MTS is typically implemented as transistors that are connected to each other by diffusion. An intra-MTS net 65 is a net that connects two transistors in an MTS. An inter-MTS net 70 is a net that connects transistors in different MTS's.

As used herein, cell characterization refers to the process of determining various characteristics (such as, for example and not as a limitation, timing, power, input capacitances, noise characteristics, etc.) of the cell. This process is used to create views/models of the cell that can be used in various steps of the design flow.

Of particular interest in the context of the present teachings, though not a limitation of the cell characteristics that may be accurately estimated in accordance herewith, is the aspect of cell timing characterization. Cell timing characterization refers to the process of creating models such as a non-linear delay model based, for example, on a detailed SPICE simulation of the transistor-level circuit representation of the cell. Cell timing can represent, for example, four different timing characteristics, namely (1) cell rise, (2) cell fall, (3) transition rise, and (4) transition fall, for a pre-defined set of output loads and input slews, on every signal-carrying input-to-output path in the circuit.

In general terms, timing T(c) of a cell c can be defined as a delay arc (cell rise, cell fall) or slew arc (transition rise, transition fall) of the cell for a given output load and input slew. Pre-layout timing Tₚᵣₑ(c) are the timing values that are obtained by characterizing a pre-layout netlist, estimated timing Tₑₛₜ(c) are the timing values that are obtained by characterizing an estimated netlist, and post-layout timing Tₚₒₛₜ(c) are the timing values that are obtained by characterizing a post-layout netlist.

Having provided the background and context of the teachings herein, the problem of obtaining an accurate pre-layout estimation of timing characteristics wherein the absolute difference of the estimated timing and the post-layout timing is minimized, in accordance with the present teachings, can be expressed as follows:

$$Minimize D ( c ) = \vert {T}_{est} ( c ) - {T}_{post} ( c ) \vert \qquad ( 1 )$$

That is, given a cell c, and its pre-layout netlist, find an estimated timing such that the absolute difference of the estimated timing and post-layout timing is minimized.

Referring back to Table 1, pre-layout timing is typically faster than post-layout timing. An estimate of post-layout timing can be obtained from pre-layout timing based on statistical analysis of differences between pre-layout and post-layout timing. A statistical estimator can be used to estimate the post-layout timing of a cell by multiplying pre-layout timing by a predetermined scale factor S such that,

$${T}_{est} ( c ) = S * {T}_{pre} ( c ) \qquad ( 2 )$$

S is specific to each technology and cell architecture, and is determined based on a small representative set of cells that are actually laid out and characterized with respect to timing. More specifically, the scale factor is calculated as follows:

$$S = \frac{1}{\vert C \vert} {\sum }_{c ∈ C} ( {T}_{post} ( c ) / {T}_{pre} ( c ) ) \qquad ( 3 )$$

where C is a representative set of cells.

To illustrate the statistical estimator relationships described by equations (2) and (3) above, consider for example, that the post-layout cell rise delay in Table 1 is estimated by the statistical estimator as 100 ps by multiplying the pre-layout delay of 91 ps by 1.10. This scale factor of 1.10 was obtained in advance using Equation (3) based on a representative set of 53 cells.

Such an estimator is advantageous in that it is applicable to any technology and cell architecture because it is formulated in a technology-independent manner. However, its accuracy is primarily limited due to the lack of consideration of the variation of layout characteristics. As will be illustrated in greater detail hereinbelow, the statistical estimator above is not very accurate since it does not account for variations in layout characteristics.

A central problem with the statistical estimator discussed above is that it cannot accurately capture the variation of layout characteristics present in different standard cells, even from within the same standard cell library. However, a constructive estimator of the present teachings takes such variations in layout characteristics into account.

The constructive estimator constructs an estimated netlist by applying the following transformations to a pre-layout netlist: folding each transistor, assigning diffusion area and perimeter to each transistor, and adding a wiring capacitance to each net. The estimated timing is then obtained by characterizing the estimated netlist.

Regarding transistor folding, since the height of a standard cell, as mentioned above, is fixed, a wide transistor in a pre-layout netlist is divided into smaller transistors to meet the cell height requirements. Folded transistors are connected in parallel to preserve the original functionality. This aspect hereof is illustrated in FIG. 5(b).

The folded transistor width, W_{f}, and the number of the folded transistors, N_{f}, are calculated as follows:

$$\begin{matrix}{W}_{f} ( t ) = W ( t ) / {N}_{f} ( t ) & ( 4 ) \\ {N}_{f} ( t ) = ⌈ W ( t ) / {W}_{fmax} ( t ) ⌉ & ( 5 ) \\ {W}_{fmax} ( t ) = \{ \begin{matrix}R ( {H}_{trans} - {H}_{gap} ) & if t is P \text{-} type \\ ( 1 - R ) ( {H}_{trans} - {H}_{gap} ) & if t is N \text{-} type\end{matrix} & ( 6 )\end{matrix}$$

where W(t) is the width of a given transistor t, ┌x┐ denotes the smallest integer greater than or equal to x, R is the ratio of heights of the P and N diffusions, Hₜᵣₐₙₛ is the height of a transistor region and H_{gap} is the height of a diffusion gap region.

The present teachings allow for two transistor folding styles, a fixed P/N ratio style and an adaptive P/N ratio style. In the fixed P/N ratio style, R is specific to a given technology and cell architecture and is given as a user-specified constant value Rᵤₛₑᵣ.

$$R = {R}_{user} \qquad ( 7 )$$

In the adaptive P/N ratio style, R is specific to a cell and is determined such that the width of the cell is minimized:

$$R = {\sum }_{t ∈ P ( c )} W ( t ) / ( {\sum }_{t ∈ P ( c ) ⋃ N ( c )} W ( t ) ) \qquad ( 8 )$$

where P(c) is a set of P-type transistors in a cell c and N(c) is a set of N-type transistors.

It is important to estimate the diffusion area and perimeter of the transistors. Given the width w and height h of the diffusion region of a transistor, the diffusion area A and perimeter P are calculated as follows:
A=w*h (9)
P=2*w+2*h (10)

The height of a diffusion region is estimated as the width of the associated transistor t:
h=W(t) (11)

The width of a diffusion region can be estimated by using one of the following simple equations, depending on whether the net n that is associated with the diffusion is an intra-MTS net or an inter-MTS net.

$$w = \{ \begin{matrix}{S}_{pp} / 2 & ( a ) if n is intra \text{-} MTS net \\ {W}_{c} / 2 + {S}_{pc} & ( b ) if n is inter \text{-} MTS net\end{matrix} \qquad ( 12 )$$

where Sₚₚ is the minimum poly-to-poly spacing, W_{c} is the contact width and S_{pc} is the minimum poly-to-contact spacing. These are given as design rules, and are illustrated in FIG. 6. While equation 12 suffices for most common IC manufacturing process today, it is possible to use more sophisticated regression models—in terms of relevant independent variables that include W_{c}, Sₚₚ, and S_{pc}, and dependent variable W(t)—for this purpose, as well.

Note that the MTS plays an important in the computation of the diffusion area and perimeter. It is the MTS that substantially controls diffusion sharing and hence controls the diffusion parasitics. This is the key to getting an accurate estimate of the diffusion parasitics.

The transformation of assigning diffusion area and perimeter to each transistor is preferably done after transistor folding is accomplished since the widths of transistors may be different before and after transistor folding. It is also noted that diffusion area and perimeter modeling should be made in conjunction with the transistor models of the target technology.

Regarding the wiring capacitance transformation, the wiring capacitance transformation adds a wiring capacitance to each net in a pre-layout netlist. Intra-MTS nets are not considered because they are typically implemented in diffusion. Similar to diffusion area/perimeter estimation, the wiring capacitance transformation is preferably done after transistor folding.

The capacitance C(n) of a net n is estimated by the following equation:

$$C ( n ) = α {\sum }_{t ∈ TDS ( n )} \vert MTS ( t ) \vert + β {\sum }_{t ∈ TG ( n )} \vert MTS ( t ) \vert + γ \qquad ( 13 )$$

where α, β and γ are constants, TDS(n) is a set of transistors whose drain or source is connected to a net n, TG(n) is a set of transistors whose gate is connected to a net n and MTS(t) is an MTS that includes a transistor t.

According to experiments conducted by the inventors of the present teachings, the above equation (13) provides an excellent correlation to actual wiring capacitances. FIG. 8 illustrates an exemplary wiring capacitance estimation. Again, it is important to note the importance of MTS in obtaining an accurate estimate of wiring capacitance. It is the MTS connectivity that primarily dictates the length of the wire(s), and hence the capacitance of the wire(s).

Equation (13) requires that the three constants α, β and γ be determined in advance. These constants are determined by multiple regression analyses based on a small representative set of cells that are actually laid out. The determination of these constants, i.e., calibration process has to be done only once for a given technology and cell architecture.

The proposed technique of accurate pre-layout estimation presented herein has been implemented within the framework of a standard cell characterization flow. Given a pre-layout netlist, cell timing is generated based on both statistical and constructive estimations and compared with post-layout timing.

As discussed hereinabove, for the statistical technique, cell timing is generated based on calibrating simulation results from a pre-layout netlist. For the constructive technique, the estimated netlist, having undergone transistor folding, area/periphery diffusion, and wiring capacitance transformations, is simulated.

The present inventors conducted experiments on two different state-of-the-art standard cell libraries implemented in 130 nm and 90 nm technologies. These standard cell libraries were chosen at different process nodes and from different vendors in order to measure the effectiveness of the techniques across varying layout styles and design rules. The cells vary from simple cells such as an inverter to complex cells that consist of approximately 30 unfolded transistors. The simulator used in these experiments was HSPICE.

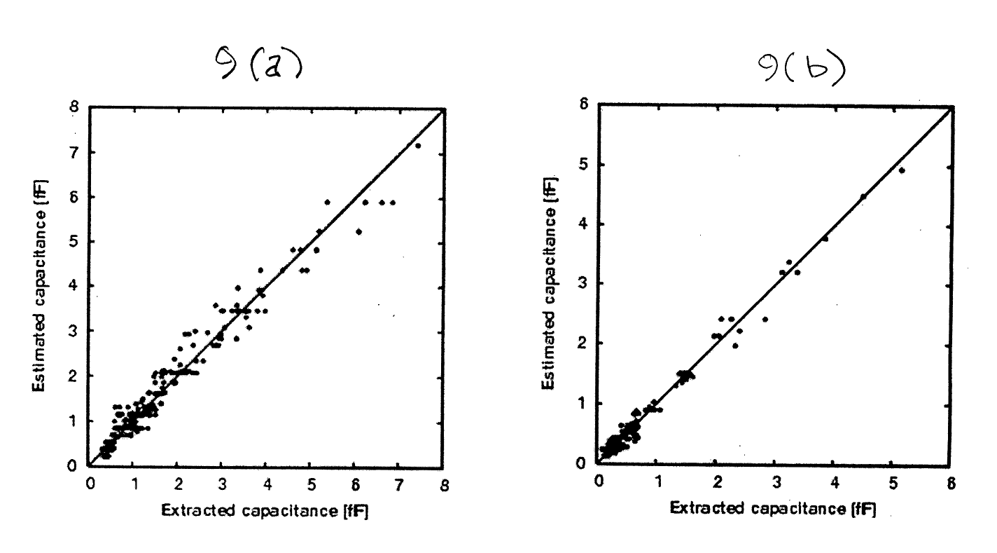

The results of the experiments demonstrate the effectiveness of the constructive technique for estimation of wiring capacitances. Wiring capacitances critically determine the quality of the constructive estimator due to their increased effects at the deep submicron geometries. FIGS. 8(a) and 8(b) depict scatter plots that compare extracted and estimated wiring capacitances for the cells in the 130 nm (FIG. 9(a)) and 90 nm (FIG. 9(b)) technologies, respectively. The extracted capacitance values are calculated from lumped C extracted netlists. The three constants α, β and γ of Equation (13) for these technologies are calculated by multiple regression analyses. This data shows the excellent correlation achieved by the wiring capacitance estimation technique of the present teachings.

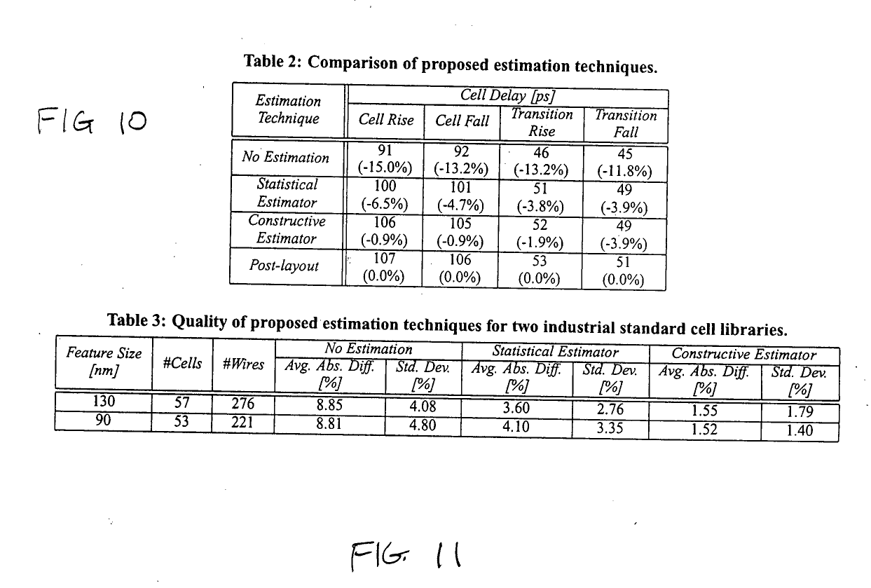

Next demonstrated is the impact of the estimators on the same cell arcs whose timing characteristics were shown in Table 1 (FIG. 1). Refer to Table 2 (FIG. 10) for the tabulation of the experimental results data. In Table 2 column 1 illustrates the estimation technique used, and columns 2 through 5 show the values of cell rise, cell fall, transition rise and transition fall, respectively. The numbers in parentheses correspond to the percentage differences compared with post-layout timing. The data for the instances of no estimation and post-layout estimation is identical to that in Table 1 (as expected).

As verified by the data listing of Table 2, the estimators (statistical and constructive) hereof greatly improve the quality of the cell timing and bring it closer to post-layout timing results. In addition, it is also clear that the constructive estimator provides an excellent pre-layout estimation of the cell timing.

Table 3 demonstrates the effectiveness of the estimators on overall cell timing for the two standard cell libraries under consideration. It is noted that each of the four cell delays (e.g., cell rise, cell fall, transition rise, and transition fall) were measured in the experiment documented by Table 3 (FIG. 11). Columns 1, 2 and 3 list the feature size of the library, the number of cells used in this experiment and the number of wires whose capacitances are estimated in this experiment, respectively. The remainder of the columns compare the quality of the cell timing for each of the proposed techniques. For example, for the 90 nm technology library, if no estimation was used, the average of the absolute differences in timing is 8.85% and a standard deviation of 4.08%. The statistical approach produces an average absolute difference of 4.10% and a standard deviation of 3.35%. It is noted that the best results are obtained by the constructive estimator, with an average absolute difference of 1.52% and a standard deviation of 1.40%.

The runtimes of the constructive estimators are very small, with typical overheads being less than 0.1% of typical SPICE simulation times. Thus, an accurate pre-layout estimation of standard cell timing characteristics can be obtained using the methods of the present teachings with relatively small computational resources and time.

Therefore, the methods hereof provide an accurate estimate of timing characteristics of transistor-level circuits in a standard-cell design framework. The accuracy of the estimation is preferably, on average, within about 1.5% of post-layout timing. The estimate is based on a fast and accurate constructive estimation technique. The estimation technique solves a critical problem affecting transistor-level optimization techniques at deep submicron geometries.

In addition to timing, the principle of pre-layout estimation of a layout characteristic of a standard cell disclosed herein is applicable to a number of standard cell characteristics, such as, for example, estimating an accurate footprint (i.e., physical geometries) and prediciting pin-placement of a cell. For instance, the cell footprint can be accurately estimated based on predicting the likely placement of devices inside a cell and their functional inter-connectivity—essentially same information as that used for pre-layout estimation of timing characteristics.

While described primarily in the context of a method, various modifications to these teachings can be made and still fall within the scope of these teachings. Accordingly, the methods disclosed herein can be implemented in an industrial software system and program instructions embodied in hardware, software, and firmware. Further by example, the teachings herein are not intended to be limited to any of the various IC design flows and processes. The teachings herein have been implemented in an industrial software system and successfully used at today's leading edge process nodes.

It should be appreciated that various modifications and changes to the method for pre-layout estimating a layout characteristic of a standard cell disclosed herein may be made without departing from the scope of this disclosure as recited in the accompanying claims.

1. An automated computer-implemented method for a pre-layout estimation of a characteristic of a standard cell, said method comprising:
receiving a pre-layout representation of said standard cell;
applying at least one transformation to said pre-layout representation to obtain an estimated representation; and
characterizing said estimated representation to obtain said pre-layout estimation of said characteristic of said standard cell.

2. The method of claim 1, wherein said pre-layout representation is selected from the group consisting of: a spice netlist, a BDD-based transistor structure representation, and a pre-layout structural representation.

3. The method of claim 1, wherein a statistical pre-layout estimator is used to obtain said pre-layout estimation of said standard cell.

4. The method of claim 3, wherein said statistical pre-layout estimation of said standard cell is accurate to within about 5 percent of a post-layout timing characterization of a parasitic-dependent timing characteristic of said standard cell.

5. The method of claim 1, wherein a constructive estimator obtains said pre-layout estimation of said standard cell that is accurate to within about 1.5 percent of a post-layout timing characterization of a parasitic-dependent timing characteristic of said standard cell.

6. The method of claim 1, wherein said characteristic comprises a parasitic-dependent standard cell characteristic.

7. The method of claim 6, wherein said parasitic-dependent standard cell characteristic is selected from the group of standard cell characteristics consisting of: timing, power, input capacitance, noise, and any other parasitic-dependent standard cell characteristic.

8. The method of claim 1, wherein said at least one transformation is selected from the group consisting of: transistor folding, diffusion area and perimeter assigning of transistors of said standard cell, and adding wiring capacitances to said pre-layout representation.

9. The method of claim 8, wherein said transistor folding transformation is performed prior to said diffusion area and perimeter assigning of transistors of said standard cell transformation, and adding wiring capacitances to said pre-layout representation.

10. The method of claim 1, wherein said at least one transformation comprises assigning a diffusion area and a perimeter to transistors of said standard cell, wherein a diffusion region width, w, is estimated as Sₚₚ/2 in the instance a net associated with said diffusion region is an intra-MTS net, and w is estimated as W_{c}/2+S_{pc} in the instance a net associated with said diffusion region is an inter-MTS net, wherein Spp is a minimum poly-to-poly spacing, W_{c} is a contact width, and S_{pc} is a minimum poly-to-poly spacing.

11. The method of claim 1, wherein said at least one transformation comprises assigning a diffusion area and a perimeter to transistors of said standard cell, wherein a diffusion region width, w, is determined using a regression analysis estimation.

12. The method of claim 1, wherein said pre-layout representation is a pre-layout netlist and said at least one transformation comprises adding a wiring capacitance to each net in said pre-layout netlist, and a capacitance C(n) of a net n is estimated as:
$$C ( n ) = α {\sum }_{t ∈ TDS ( n )} \vert MTS ( t ) \vert + β {\sum }_{t ∈ TG ( n )} \vert MTS ( t ) \vert + γ$$
wherein α, β and γ are constants, TDS(n) is a set of transistors whose drain or source is connected to a net n, TG(n) is a set of transistors whose gate is connected to said net n and MTS(t) is an MTS(Maximal Transistor Series) that includes a transistor.

13. The method of claim 12, wherein said constants α, β and γ are predetermined prior to said application of said at least one transformation to said pre-layout representation.

14. The method of claim 12, wherein said constants α, β and γ are determined by multiple regression analysis based on a representative set of laid out cells for a particular technology and cell architecture.

15. The method of claim 1, wherein said characteristic comprises a parasitic-dependent timing characteristic of said standard cell and said at least one transformation comprises diffusion area and perimeter assigning of transistors of said standard cell, and adding wiring capacitances to said pre-layout representation.

16. The method of claim 1, wherein said characteristic is selected from the group consisting of: a cell footprint and a pin placement of said cell.

17. A storage medium including computer readable program instructions for an automated computer-implemented method for obtaining a pre-layout estimation of a characteristic of a standard cell, said storage medium comprising:
program instructions for receiving a pre-layout representation of a standard cell;
program instructions for applying at least one transformation to said pre-layout representation to obtain an estimated representation; and
program instructions for characterizing said estimated representation to obtain said pre-layout estimation of said characteristic of said standard cell.

18. The storage medium of claim 17, wherein said pre-layout representation is selected from the group consisting of: a spice netlist, a BDD-based transistor structure representation, and a pre-layout structural representation.

19. The storage medium of claim 17, further comprising program instructions for a statistical estimator to obtain said pre-layout estimation of said standard cell.

20. The storage medium of claim 19, wherein said statistical pre-layout estimation of said standard cell is accurate to within about 5 percent of a post-layout timing characterization of a parasitic-dependent timing characteristic of said standard cell.

21. The storage medium of claim 17, wherein a constructive estimator obtains a pre-layout estimation of said standard cell that is accurate to within about 1.5 percent of a post-layout timing characterization of a parasitic-dependent timing characteristic of said standard cell.

22. The storage medium of claim 17, wherein said characteristic comprises a parasitic-dependent standard cell characteristic.

23. The storage medium of claim 22, wherein said parasitic-dependent standard cell characteristic is selected from the group of standard cell characteristics consisting of: timing, power, input capacitance, noise, and any other parasitic-dependent standard cell characteristic.

24. The storage medium of claim 16, wherein said at least one transformation is selected from the group consisting of: transistor folding, diffusion area and perimeter assigning of transistors of said standard cell, and adding wiring capacitances to said pre-layout representation.

25. The storage medium of claim 24, wherein said transistor folding transformation is performed, per program instructions, prior to said diffusion area and perimeter assigning of transistors of said standard cell transformation, and adding wiring capacitances to said pre-layout representation.

26. The storage medium of claim 17, wherein said at least one transformation comprises assigning a diffusion area and a perimeter to transistors of said standard cell, wherein a diffusion region width, w, is estimated as Sₚₚ/2 in the instance a net associated with said diffusion region is an intra-MTS net, and w is estimated as W_{c}/2+S_{pc} in the instance a net associated with said diffusion region is an inter-MTS net, wherein Spp is a minimum poly-to-poly spacing, W_{c} is a contact width, and S_{pc} is a minimum poly-to-poly spacing.

27. The method of claim 17, wherein said at least one transformation comprises assigning a diffusion area and a perimeter to transistors of said standard cell, wherein a diffusion region width, w, is determined using a regression analysis estimation.

28. The storage medium of claim 17, wherein said pre-layout representation is a pre-layout netlist and said at least one transformation comprises adding a wiring capacitance to each net in said pre-layout netlist, and a capacitance C(n) of a net n is estimated as:
$$C ( n ) = α {\sum }_{t ∈ TDS ( n )} \vert MTS ( t ) \vert + β {\sum }_{t ∈ TG ( n )} \vert MTS ( t ) \vert + γ$$
wherein α, β and γ are constants, TDS(n) is a set of transistors whose drain or source is connected to a net n, TG(n) is a set of transistors whose gate is connected to said net n and MTS(t) is an MTS(Maximal Transistor Series) that includes a transistor.

29. The storage medium of claim 28, wherein said constants α, β and γ are predetermined prior to said application of said at least one transformation to said pre-layout representation.

30. The storage medium of claim 28, wherein said constants α, β and γ are determined by multiple regression analysis based on a representative set of laid out cells for a particular technology and cell architecture.

31. The storage medium of claim 17, wherein said characteristic comprises a parasitic-dependent timing characteristic of said standard cell and said at least one transformation comprises diffusion area and perimeter assigning of transistors of said standard cell, and adding wiring capacitances to said pre-layout representation.

32. The storage medium of claim 17, wherein said characteristic is selected from the group consisting of: a cell footprint and a pin placement of said cell.
